(19) United States
(12) Patent Application Publication
(10) Pub. No.: US 2008/0137492 A1
(43) Pub. Date: Jun. 12, 2008

(54) Optical disc apparatus

(75) Inventors: Sojiro Kirihara, Kawasaki (JP); Shinya Tsubota, Mito (JP); Yoshiyuki Tanaka, Kawasaki (JP)

Correspondence Address: MCDERMOTT WILL & EMERY LLP, 600 13TH STREET, N.W., WASHINGTON, DC, 20005-3096, US

(73) Assignee: HITACHI-LG DATA STORAGE, INC.

(21) Appl. No.: 11/889,545

(22) Filed: Aug. 14, 2007

(30) Foreign Application Priority Data
Dec. 11, 2006 (JP) 2006-333465

(51) Int. Cl. G11B 7/00

(52) U.S. Cl. 369/44.14

(57) ABSTRACT

An optical disc apparatus has a bottom cover member provided with an opening. A peripheral part of a unit mechanism deck member serving as a support member in a functional unit mechanism or a motor base holding a spindle motor and fixed to the unit mechanism deck member is projected outside through the opening when the optical disc apparatus is set in a loaded state to space a part of the functional unit mechanism projecting in a direction opposite to a direction in which the peripheral part of the unit mechanism deck member or the motor base is projected outside from a surface of the optical disc.

### CLAIM OF PRIORITY

The present application claims priority from Japanese application serial No. P2006-333465, filed on Dec. 11, 2006, the content of which is hereby incorporated by reference into this application.

### BACKGROUND OF THE INVENTION

1. Technical Field of the Invention

The present invention relates to an optical disc apparatus of a unit mechanism system and, more particularly, to a structure of an optical disc apparatus with a small thickness.

2. Description of the Related Art

A thin optical disc apparatus of a unit mechanism system having a thickness of about 9.5×10⁻³ m has already been put to practical use. Recently, efforts have been made to provide a still thinner optical disc apparatus of, for example, about 7.0×10⁻³ m in thickness for notebook-sized personal computers. Techniques relating to the present invention are mentioned in, for example, JP-A 2005-251363 and JP-A 2005-293647. A structure mentioned in JP-A 2005-251363 has a top plate, namely, a top wall of a case, provided with a contact projection formed at a position facing a turntable such that the edge of the central opening of an optical disc is pressed against the projection when the optical disc is chucked to make sure that the optical disc is securely chucked by a chucking operation even if the top plate has a low rigidity. A structure mentioned in JP-A 2005-293647 to form a disc apparatus easily in a small size attaches a lead screw for moving an optical pickup and a moving motor, namely, a slide motor, for driving the lead screw to a case body 110. Shown in FIG. 2B of assistance in explaining the related art is a case body 2 provided with a cut to avoid interference between support members supporting the lead screw, and the case body. A part of the moving motor protrudes through a part of the case body 2 provided with the cut.

### SUMMARY OF THE INVENTION

To form a thin optical disc apparatus of a unit mechanism system by reducing the distance between a surface of an optical disc and a bottom cover member, a functional unit mechanism needs to be disposed closer to the bottom cover member.

A conventional optical disc apparatus shown in FIG. 8 has a functional unit mechanism 5′ formed by mounting a spindle motor 2′ and an optical pickup 3′ on a unit mechanism deck member 5a′ and disposed close to a bottom cover member 8′. In an unloaded state where a damper 11′ is not fitted in a central opening of an optical disc 200, a motor base 25′ and a peripheral part 5a₁′ of the unit mechanism deck member 5a′ are close to the inside surface of the bottom cover member 8′. Therefore, in the unloaded state, the unit mechanism deck member 5a′ can turn toward the bottom cover member 8′ on a fulcrum through a small angle. Consequently, the free end of the damper 11′ is at a position higher than that of the position of the recording surface 200a of the optical disc 200 in Z axis direction, the optical disc 200 collides with the damper 11′ when the optical disc 200 is loaded into the optical disc apparatus and the optical disc 200 cannot be normally loaded into the optical disc apparatus. In FIG. 8, 3a′ denotes an objective lens; 4′, a chassis; 8a′, a base board, a bottom sheet; and 12′, a disc support portion for supporting the plane of the optical disc 200.

In an optical disc apparatus illustrated in FIG. 2B attached to the specification of JP-A 2005-293647, a moving electric motor (slide motor) disposed near a spindle motor is the closest to a case body 2.

In view of the status of the conventional technique, it is an object of the present invention to provide a thin optical disc apparatus of a unit mechanism system in which a protruding part of a functional unit mechanism, such as a clamper, does not come into contact with a surface of an optical disc in an unloaded state.

The present invention provides an optical disc apparatus of a unit mechanism system including a bottom cover member provided with an opening through which a peripheral part of a unit mechanical deck member, namely, a support member for supporting a functional unit mechanism, or a motor base for fixedly holding a spindle motor on the unit mechanism deck member projects outside, in which a gap is formed between a part projecting in a direction opposite a direction in which the peripheral part of the unit mechanism deck member and the motor base project and facing the surface of an optical disc.

### BRIEF DESCRIPTION OF THE DRAWINGS

FIG. 1 is a plan view of an optical disc apparatus in a preferred embodiment according to the present invention;

FIG. 2 is a rear elevation of the optical disc apparatus shown in FIG. 1;

FIG. 3 is an enlarged view of a part of FIG. 2;

FIG. 4 is a plan view of a bottom cover member included in the optical disc apparatus shown in FIG. 1;

FIGS. 5A and 5B are sectional views of the optical disc apparatus shown in FIG. 1 in an unloaded state;

FIG. 6 is a sectional view of the optical disc apparatus shown in FIG. 1 in a loaded state;

FIG. 7 is a sectional view of an optical disc apparatus in a modification of the optical disc apparatus shown in FIG. 1 in a loaded state; and

FIG. 8 is a sectional view of assistance in explaining a problem to be solved by the present invention.

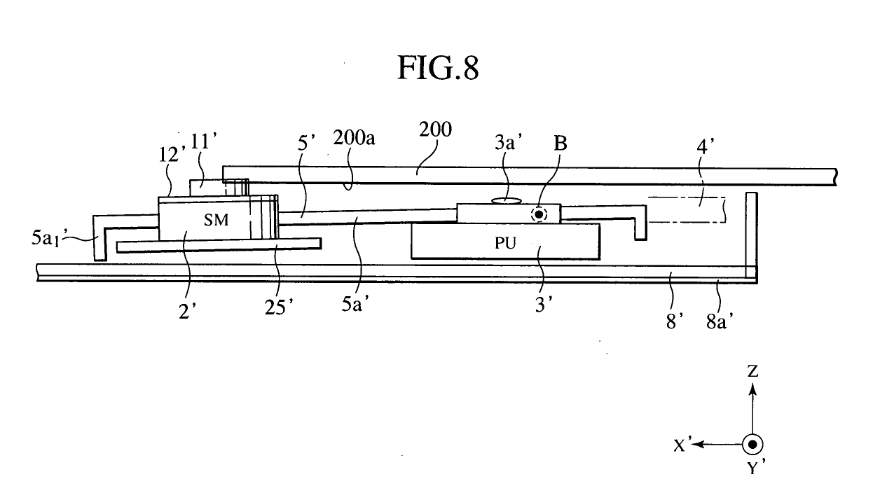

### DESCRIPTION OF THE PREFERRED EMBODIMENT

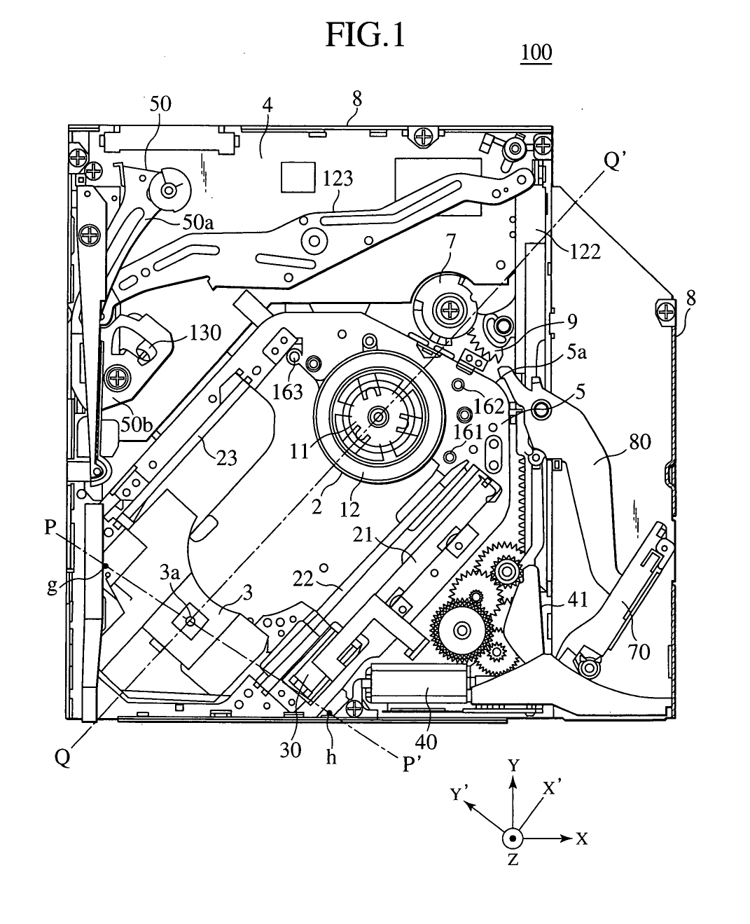

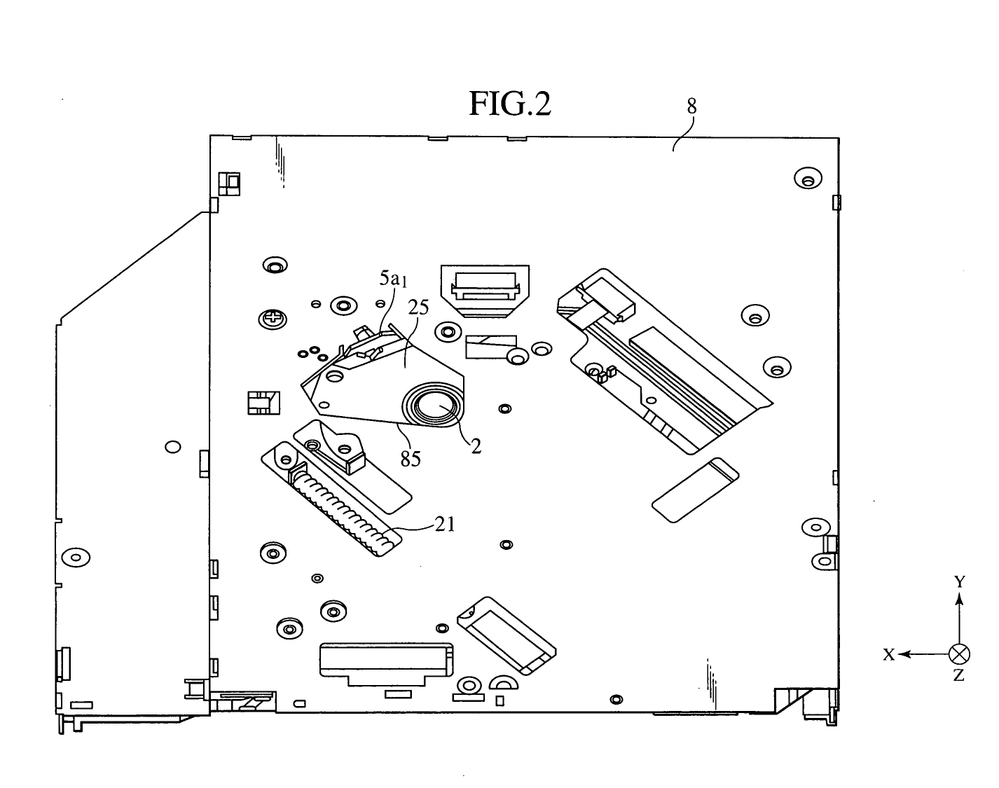

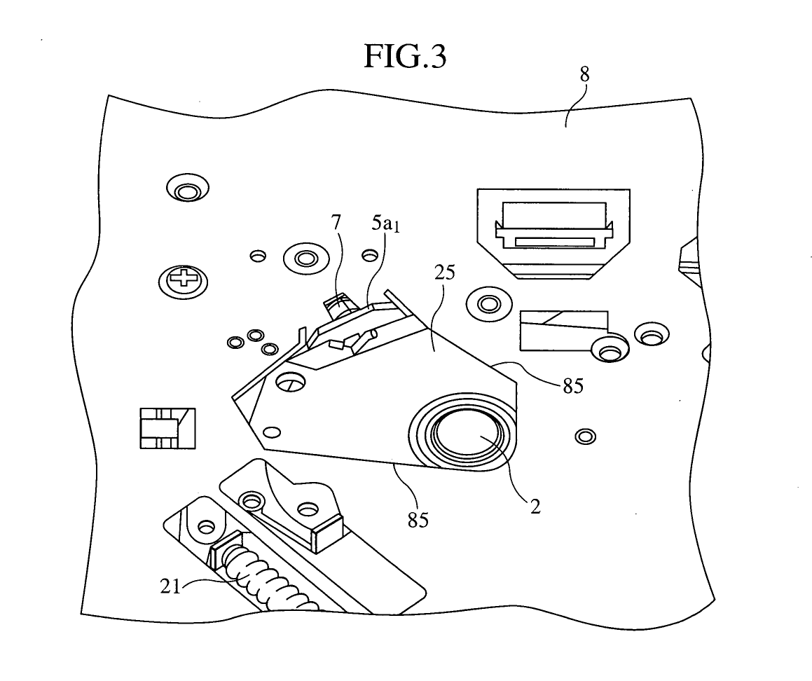

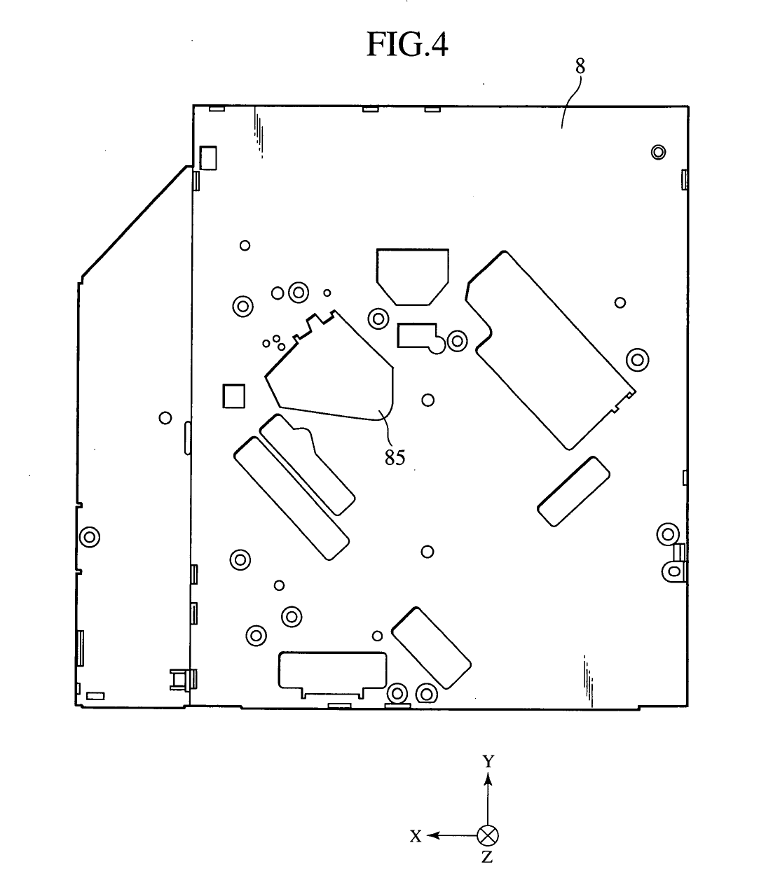

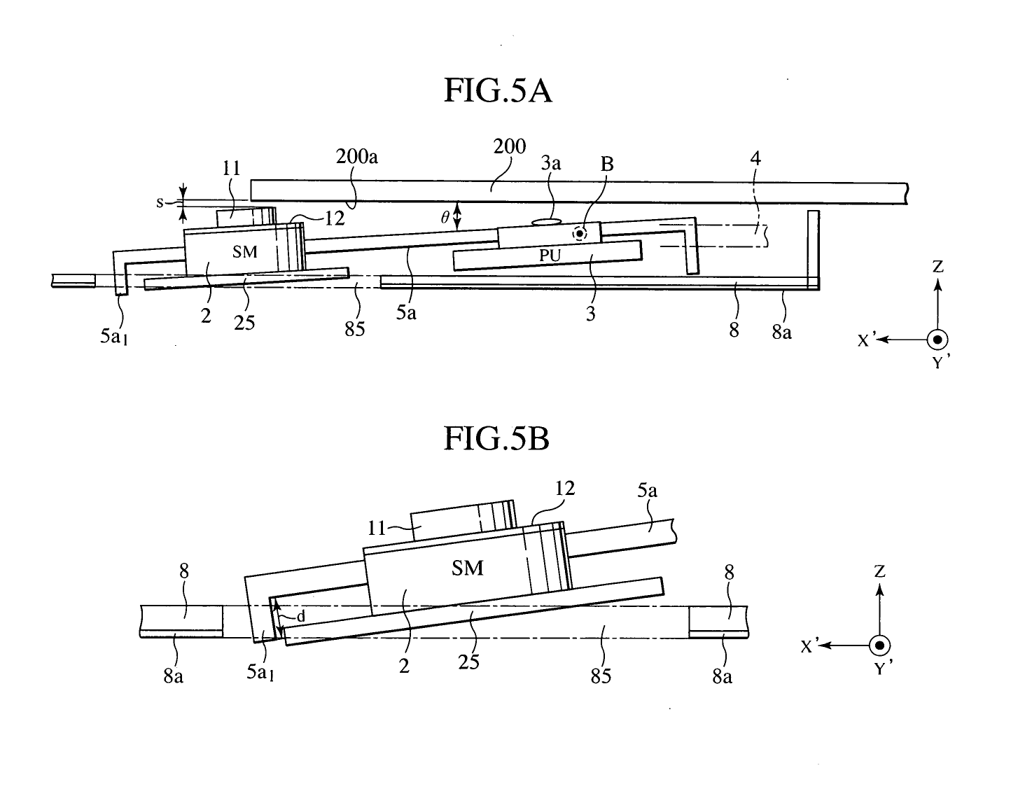

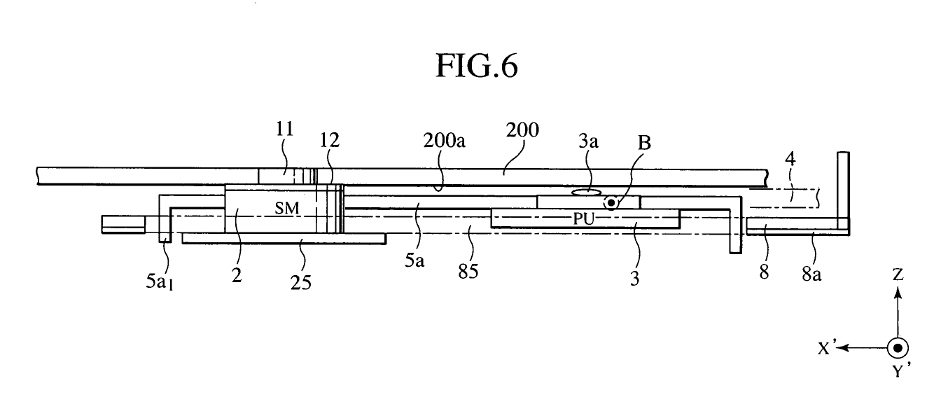

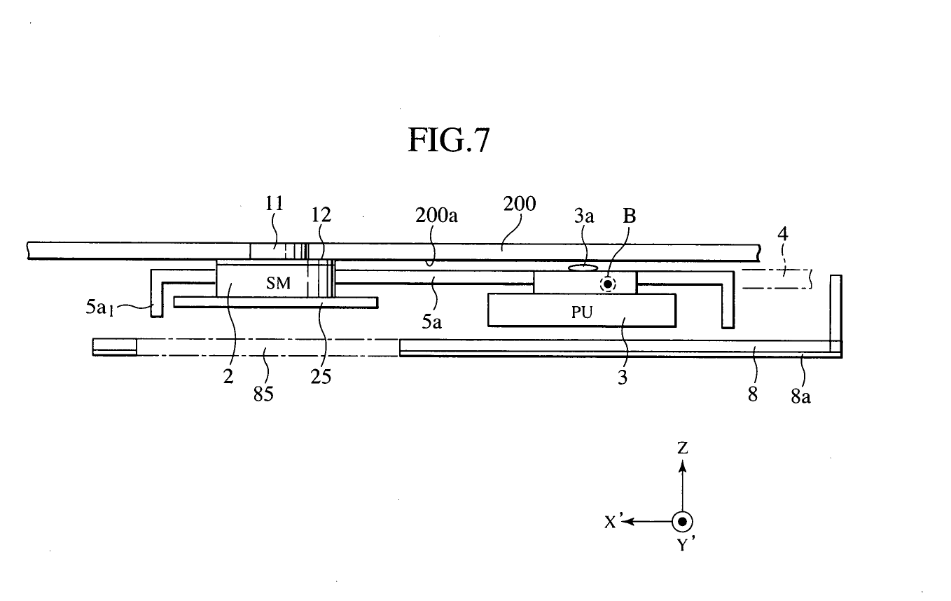

FIG. 1 is a plan view of an optical disc apparatus in a preferred embodiment according to the present invention, FIG. 2 is rear elevation of the optical disc apparatus shown in FIG. 1, FIG. 3 is an enlarged view of a part of FIG. 2, FIG. 4 is a plan view of a bottom cover member included in the optical disc apparatus shown in FIG. 1, FIGS. 5A and 5B are sectional views of the optical disc apparatus shown in FIG. 1 in an unloaded state, FIG. 6 is a sectional view of the optical disc apparatus shown in FIG. 1 in a loaded state, and FIG. 7 is a sectional view of an optical disc apparatus in a modification of the optical disc apparatus shown in FIG. 1 in a loaded state. In FIGS. 1 to 7, the same parts are designated by the same reference characters, respectively, and the same coordinate axes are used.

FIG. 1 shows the top side (positive side in the Z axis direction=the mounting side) of an optical disc apparatus 100 in a preferred embodiment according to the present invention, there are shown a spindle motor 2 for rotating an optical disc (not shown), an optical pickup 3, an objective lens 3a, a chassis 4, namely, a first base member, a functional unit mechanism 5 including the spindle motor 2 and the optical pickup 3, a unit mechanism deck member 5a, namely, a support member included in the functional unit mechanism 5, a lifting mechanism 7 for turning the unit mechanism deck member 5a on fulcrums g and h relative to the chassis 4, a bottom cover member 8 disposed on the outer side of the chassis 4, a drive gear 9 for driving the lifting mechanism 7, a projecting damper 11 to be fitted in a central opening of the optical disc, not shown, to restrain the optical disc from radial movement, a disc support member 12 on which the optical disc is supported in a plane with a part around the central opening thereof seated when the damper 11 is fitted in the central opening of the optical disc, a lead screw 21 for moving the optical pickup 3 in substantially radial directions, guide members 22 and 23 for guiding the moving optical pickup 3, a slide motor 30 for rotatively driving the lead screw 21, a loading motor 40 for moving the optical disc in a loading direction to load the optical disc into the optical disc apparatus 100 and in an unloading direction to unload the optical disc from the optical disc apparatus 100, a gear train 41 for transmitting the driving force of the loading motor 40 to a load, an arm member 50 for applying driving force to the optical disc to load the optical disc through a front panel (not shown), into the optical disc apparatus 100, i.e., to move the optical disc in a Y-axis direction, and to unload the optical disc through the front panel from the optical disc apparatus 100, an arm part 50a of the arm member 50, an arm support member 50b supporting the arm part 50a for turning, a disc slot arm member 70 for pulling the optical disc into the optical disc apparatus 100, an auxiliary lever 80, levers 122 and 133 for loading and unloading the optical disc, a switch 130 for connecting the loading motor 40 to and disconnecting the loading motor 40 from a power supply, and a straight line P-P′ passing the fulcrums g and h. The slide motor 30, the lead screw 21 and the guide members 21 form a driving and guiding mechanism. The slide motor 30 is connected to an end part of the lead screw 21 near the fulcrum h or the straight line P-P′ passing the fulcrums g and h and far from the spindle motor 2 to drive the lead screw 21 for rotation.

The lead screw 21, the guide members 22 and 23 and the slide motor 30 are mounted on the unit mechanism deck member 5a, namely, a second base member, in addition to the spindle motor 2 and the optical pickup 3. The spindle motor 2 is attached to a motor base, not shown, and the motor base is fixed to the back surface (negative side in the Z axis direction) of the unit mechanism deck member 5a with screws. The motor base is fixed to the unit mechanism deck member 5a with the screws at positions 161, 162 and 163.

When the optical disc is loaded into the optical disc apparatus 100 for a recording or reproducing operation, the lifting mechanism 7 turns the unit mechanism deck member 5a on the fulcrums g and h about the straight line P-P′ to lift up the unit mechanism deck member 5a from a first position, where the unit mechanism deck member 5a is held in the unloaded state, relative to the chassis 4 so that the damper 11 is fitted in the central opening of the optical disc inserted into the optical disc apparatus 100. The lifting mechanism 7 lifts up the unit mechanism deck member 5a further to a second position so that the optical disc is chucked by the damper 11 with the part of the optical disc around the central opening seated on the disc support member 12. Subsequently, the lifting mechanism 7 turns the unit mechanism deck member 5a on the fulcrums g and h in the opposite direction to lower the unit mechanism deck member 5a relative to the chassis 4 to a third position between the first and the second position. The unit mechanism deck member 5a is held at the third position for a recording or reproducing operation.

The rotative driving force of the loading motor 40 is transmitted through the gear train 41 to the levers 122 and 123 to move the optical disc for loading or unloading. The levers 122 and 123 holds the optical disc in a predetermined state, take the optical disc into the optical disc apparatus 100 to a chucking position, and moves the optical disc from the chucking position to eject the optical disc from the optical disc apparatus 100.

The bottom cover member 8 is connected to the chassis 4 and is provided with an opening (not shown). A part of the functional unit mechanism 5 is projected outside through the opening of the bottom cover member 8 at least in the unloaded state.

The top side (positive side in the Z axis direction) of the optical disc apparatus 100 is covered with a top cover member (not shown). The thickness of the optical disc apparatus 100, i.e., the distance between the outside surface of the top cover member and the outside surface of the bottom cover member 8 or the bottom sheet 8a, is at least 9.5×10⁻³ m or less, for example, about 7.0×10⁻³ m.

In the following description, the components shown in FIG. 1 are designated by the same reference characters.

In FIG. 2, reference numeral 85 denotes an opening formed in the bottom cover member 8; 25, the motor base to which the spindle motor 2 is attached; and 5a₁, a peripheral part of the unit mechanism deck member 5a. The opening 85 coincides with the peripheral part 5a₁ of the unit mechanism deck member 5a, namely, a projecting part of the functional unit mechanism 5 projecting in the −Z-axis direction, and the motor base 25. The peripheral part 5a₁ of the unit mechanism deck member 5a included in the functional unit mechanism 5 and the motor base 25 project outside through the opening 85 in the −Z-axis direction at least when the unit mechanism deck member 5a is at the first position for the unloaded state. Since the peripheral part 5a₁ of the unit mechanism deck member 5a, and the motor base 25 project outside through the opening 85, a gap is formed between the damper 11 projecting in the Z-axis direction and the surface, facing the damper 11, of the optical disc loaded into the optical disc apparatus 100. Thus the unit mechanism deck member 5a is inclined at an increased inclination to the surface of the optical disc to reduce the height of the tip of the damper 11 at an upper part of the spindle motor 21 with respect to the Z-axis direction so that the clapper 11 is spaced apart from the surface of the optical disc by projecting a part of either of the unit mechanism deck member 5a and the motor base 25 or parts of both the unit mechanism deck member 5a and the motor base 25 outside in the −Z-axis direction through the opening 85. Since the damper 11 is spaced apart from the optical disc, the optical disc can be loaded into the optical disc apparatus 100 without being interfered with by the damper 11. Thus the optical disc apparatus 100 can be formed in a small thickness.

FIG. 3 shows the opening 85 shown in FIG. 2, the peripheral part 5a₁ of the unit mechanism deck member 5a and the motor base 25 in an enlarged view. The peripheral part 5a₁ of the unit mechanism deck member 5a projecting outside through the opening 85 is near the lifting mechanism 7.

Referring to FIG. 4 showing the bottom cover member 8 of the optical disc apparatus 100 shown in FIG. 1 in a plan view, the bottom cover member 8 covers the back side (negative side in the Z axis direction) of the optical disc apparatus 100. The opening 85 formed in the bottom cover member 8 coincides with the peripheral part 5a₁ of the unit mechanism deck member 5a, and the motor base 25. The peripheral side part 5a₁ and the motor base 25 extend outside through the opening 85 of the bottom cover member 8 at least in the unloaded state.

FIGS. 5A and 5B are sectional views of the optical disc apparatus shown in FIG. 1 in an unloaded state. FIG. 5A is a sectional view taken on the line Q-Q′ in FIG. 1. In FIG. 5A, the unit mechanism deck member 4a is at the first position. FIG. 5B is an enlarged view of a part of FIG. 5A including the opening 85 of the bottom cover member 8, the peripheral part 5a₁ of the unit mechanism deck member 5a and the motor base 25. In FIG. 5B, parts of the peripheral part 5a₁ of the unit mechanism deck member 5a and the motor base 25 extend in the opening 85.

Shown in FIGS. 5A and 5B are the optical disc 200 to be loaded into the optical disc apparatus 100, the recording surface 200a of the optical disc 200, a fulcrum B representing the fulcrums g and h, an inclination θ at which the unit mechanism deck member 5a at the first position inclines to the recording surface 200a of the optical disc 200, the distance s between the tip of the damper 11 and the recording surface 200a of the optical disc 200, namely, the thickness of a gap between the tip of the damper 11 and the recording surface 200a of the optical disc 200, when the unit mechanism deck member 5a is at the first position, the height d of the L-shaped peripheral part 5a₁ of the unit mechanism deck member 5a, and the bottom sheet 8a attached to the outside surface of the bottom cover member 8. When the unit mechanism deck member 5a is held at the first position by the lifting mechanism 7, the unit mechanism deck member 5a is inclined to the recording surface 200a of the optical disc 200 at the inclination θ. In this state, parts of the peripheral part 5a₁ of the unit mechanism deck member 5a, and the motor base 25 project outside in the −Z-axis direction through the opening 85, and the tip of the damper 11 is separated from the recording surface 200a of the optical disc 200 by the distance s. The unit mechanism deck member 5a can be inclined to the recording surface 200a of the optical disc 200 at the inclination θ and the tip of the damper 11 can be separated from the recording surface 200a of the optical disc 200 by the distance s by thus partly projecting the peripheral part 5a₁ of the unit mechanism deck member 5a and the motor base 25 outside through the opening 85. The distance s is determined so that the tip of the damper 11 may not touch the recording surface 200a of the optical disc 200. When the height d of the L-shaped peripheral part 5a₁ of the unit mechanism deck member 5a is big, the peripheral part 5a₁ can compensate the reduction of the rigidity of the unit mechanism deck member 5a when the unit mechanism deck member 5a is formed in a small thickness. The inclination θ meets, for example, an inequality: 10°>θ>0°.

FIG. 6 shows the optical disc apparatus 100 in a loaded state in a sectional view. The unit mechanism deck member 5a is moved in the Z-axis direction to the second position, where the unit mechanism deck member 5a is in a chucking state by the lifting mechanism 7 from the first position, where the unit mechanism deck member 5a is inclined as shown in FIG. 5. The damper 11 chucks the optical disc with the unit mechanism deck member 5a held at the second position. Then, the unit mechanism deck member 5a is moved in the −Z-axis direction to the third position between the first and the second position to set the optical disc apparatus 100 in the loaded state in which a recording or a reproducing operation can be accomplished. In the loaded state shown in FIG. 6, where the unit mechanism deck member 5a is held at the third position, the peripheral part 5a₁ of the unit mechanism deck member 5a and the motor base 25 are projected outside through the opening 85 of the bottom cover member 8.

FIG. 7 is a sectional view of a modification of the optical disc apparatus 100 shown in FIG. 1 in a loaded state. A unit mechanism deck member 5a is moved in the Z-axis direction to the second position from the first position shown in FIG. 5. Then, the unit mechanism deck member 5a is moved in the −Z-axis direction to the third position between the first and the second position to set the optical disc apparatus in the loaded state in which a recording or a reproducing operation can be accomplished. In the loaded state shown in FIG. 7, where the unit mechanism deck member 5a is held at the third position, the peripheral part 5a₁ of the unit mechanism deck member 5a and the motor base 25 are inside the bottom cover member 8 and are not projected outside through the opening 85 of the bottom cover member 8.

The bottom cover member 8 of the optical disc apparatus 100 is provided with the opening 85, and the peripheral part 5a₁ of the unit mechanism deck member 5a and the motor base 25 are projected outside through the opening 85. Therefore, the optical disc apparatus 100 can be formed in a small thickness without deteriorating the reliability thereof and without reducing the height d of the L-shaped peripheral part 5a₁ of the unit mechanism deck member 5a and the respective thicknesses of the spindle motor 2 and the motor base 25, and the height of the damper 11. The optical disc apparatus 100 can be formed in a small thickness, i.e., the distance between the outside surface of the top cover member and the outside surface of the bottom cover member 8 or the bottom sheet 8a, is at least 9.5×10⁻³ m or less, for example, about 7.0×10⁻³ m.

Although the present invention has been described in its preferred embodiment with a certain degree of particularity, obviously many changes and variations are possible therein. It is therefore to be understood that the present invention may be practiced otherwise than as specifically described therein without departing from the scope and spirit thereof.

What is claimed is:

1. An optical disc apparatus capable of writing information to or reading information from an optical disc by driving the optical disc for rotation and projecting a laser beam on the optical disc by an optical pickup, said optical disc apparatus comprising:
a top cover member covering a top side of the optical disc apparatus;
a first base member serving as a base frame;
a functional unit mechanism including the spindle motor, a motor base holding the spindle motor, the optical pickup, and a moving and guiding mechanism for moving the optical pickup in a radial direction substantially parallel to a radius of the optical disc;
a second base member supporting the functional unit mechanism, and capable of turning relative to the first base in a plane substantially perpendicular to a plane containing the first base between a first position where the functional unit mechanism is in an unloaded state and a second position where the functional unit mechanism is in a disc chucking state; and
a bottom cover member covering a bottom side of the optical disc apparatus, connected to the first base member, and provided with an opening corresponding to a peripheral part of the second base member and the motor base of the functional unit mechanism;
wherein either of the peripheral part of the second base member or the motor base of the functional unit mechanism is projected outside or both the peripheral part of the second base member and the motor base of the functional unit mechanism are projected outside through the opening of the bottom cover when the second base member is at the first position.

2. The optical disc apparatus according to claim 1, wherein the unit mechanism includes a projecting clamper, to be fitted in a central opening of the optical disc to chuck the optical disc and to restrain the optical disc from radial movement, fixed to a rotating part of the spindle motor so as to project from the rotating part, and a tip part of the damper is spaced apart from a surface facing the damper of the optical disc loaded into the optical disc apparatus when the second base member is at the first position.

3. The optical disc apparatus according to claim 1, wherein the functional unit mechanism is set in a loaded state in which information can be written to or read from the optical disc when the second base member is placed at a third position between the first and the second position, and either of the peripheral part of the second base member or the motor base of the functional unit mechanism is projected outside or both the peripheral part of the second base member and the motor base of the functional unit mechanism are projected outside through the opening of the bottom cover when the functional unit mechanism is set in the loaded state.

4. The optical disc apparatus according to claim 1, wherein the moving and guiding mechanism of the functional unit mechanism includes a slide motor for driving a lead screw to move the optical pickup, and the slide motor is disposed on the side of one of opposite end parts of the lead screw farther from the spindle motor.

5. The optical disc apparatus according to claim 1, wherein a distance between respective outer surfaces of the top cover member and the bottom cover member is 9.5×10⁻³ m or less.

6. The optical disc apparatus according to claim 2, wherein a distance between respective outer surfaces of the top cover member and the bottom cover member is 9.5×10⁻³ m or less.

7. The optical disc apparatus according to claim 3, wherein a distance between respective outer surfaces of the top cover member and the bottom cover member is 9.5×10⁻³ m or less.

8. The optical disc apparatus according to claim 4, wherein a distance between respective outer surfaces of the top cover member and the bottom cover member is 9.5×10⁻³ m or less.
